(19) United States
(12) Patent Application Publication
(10) Pub. No.: US 2015/0281261 A1
(43) Pub. Date: Oct. 1, 2015

(54) DETECTING PROXY-BASED COMMUNICATIONS

(71) Applicant: International Business Machines Corporation, Armonk, NY (US)

(72) Inventors: Shahar T. Kohanim, Rehovot (IL); Shmulik Regev, Tel Aviv (IL)

(73) Assignee: International Business Machines Corporation, Armonk, NY (US)

(21) Appl. No.: 14/225,945

(22) Filed: Mar. 26, 2014

(51) Int. Cl. H04L 29/06; H04L 29/08

(52) U.S. Cl. CPC H04L 63/1408; H04L 67/28

(57) ABSTRACT

Detecting proxy-based communications by determining a plurality of time delays, determining a representative time delay from the plurality of time delays, and identifying the sender as a proxy by determining that the representative time delay is consistent with a predefined time delay that is associated with proxy-based communications.

### FIELD OF THE INVENTION

The present invention relates generally to detection of third party activity, and more particularly, to detection of proxy-based communications, directed through an intermediate computer.

### BACKGROUND OF THE INVENTION

In computer networks, a proxy is a server, computing system, or an application that acts as an intermediary for requests from clients seeking resources from other servers. A client may connect to a proxy, requesting some service, such as a file, connection, web page, or other resource available from a different server. The proxy then evaluates the request as a way to simplify and control the complexity of the request.

### SUMMARY

In one aspect of the invention a method is provided for detecting proxy-based communications by determining a plurality of time delays, wherein determining the plurality of time delays comprises, for each of the plurality of time delays: detecting the receipt of an acknowledgement at a first time, where the acknowledgement is responsive to a communication sent to a sender of the acknowledgement; detecting the receipt of a data request at a second time, where the data request is sent by the sender of the acknowledgement following the acknowledgement; and determining a time delay between the first time and the second time. Determining a representative time delay from the plurality of time delays, and identifying the sender as a proxy by determining that the representative time delay is consistent with a predefined time delay that is associated with proxy-based communications.

In other aspects of the invention systems and computer program products embodying the invention are provided.

### BRIEF DESCRIPTION OF THE SEVERAL VIEWS OF THE DRAWINGS

FIG. 1 is a simplified conceptual illustration of a system for detecting proxy-based communications via a computer network, constructed and operative in accordance with an embodiment of the invention;

FIG. 2 is a simplified flowchart illustration of an exemplary method of operation of the system of FIG. 1, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

Embodiments of the present invention recognize that fraudulent use of computer network-based financial applications, such as online banking applications, frequently involves a perpetrator performing a financial transaction via an intermediate computer, or “proxy,” in order to obscure the true origin of fraudulent transaction. Embodiments of the present invention allow for making determinations as to whether a communication is proxy-based. Such embodiments allow for intelligent decisions with regard to access and security measures. Implementation of embodiments of the invention may take a variety forms, and exemplary implementation details are discussed subsequently with reference to the Figures.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

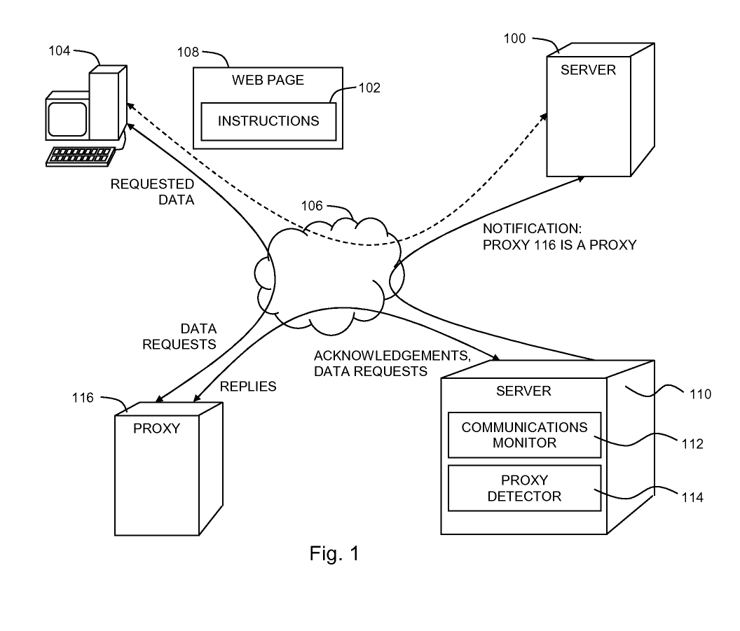

Reference is now made to FIG. 1 which is a simplified conceptual illustration of a system for detecting proxy-based communications via a computer network, constructed and operative in accordance with an embodiment of the invention. In the system of FIG. 1, a computer 100, hereinafter referred to as server 100, is configured to provide executable computer software instructions 102, hereinafter referred to as instructions 102, to a computer 104, hereinafter referred to as client 104, via a computer network 106, such as the Internet. Server 100 may, for example, provide instructions 102 in the form of JavaScript™ instructions that are embedded within a web page 108 that server 100 provides to client 104 as part of a financial transaction, where client 104 is configured to execute instructions 102 in accordance with conventional techniques. The connection between client 104 and server 100 is shown in dashed lines to indicate that server does not know if client 104 is communicating directly with server 100 or if client 104 is communicating with server 100 via a proxy.

Instructions 102 are configured to send multiple requests to receive data via computer network 106, such as from a computer 110, hereinafter referred to as server 110, or from server 100, in which case references to server 110 hereinbelow may be understood as referring to server 100. The requests for data may, for example, be requests to receive one or more images from server 110.

A communications monitor 112, which may be hosted by server 110, is configured to detect when server 110 receives communications from other computers, and particularly detect the receipt of requests to establish communications with server 110, such as using the Transmission Control Protocol (TCP), requests to receive data from server 110, and acknowledgements received in response to server 110 responding to such requests.

Communications monitor 112 is preferably configured to recognize received requests for specific data items, among predefined data items that are known to communications monitor 112, as being related to the operations described herein for detecting proxy-based communications. Thus, if server 110 receives a request for a data item that is not among the predefined data items, communications monitor 112 preferably ignores the request.

Communications monitor 112 is also configured to record the time, preferably to the nearest millisecond or smaller unit of time measurement, when such communications are received, preferably recording this information separately by sender, such as may be identified by the sender's network address as indicated within the communication, and by communications channel, such as may be identified by the communications port via which the communication was received.

A proxy detector 114, which may be hosted by server 110, is configured to use the information gathered by communications monitor 112 as described above and determine a time delay between the time when server 110 receives an acknowledgement from a particular sender via a particular communications channel in response to server 110 responding to a request, from the same sender and via the same communications channel, to establish communications with server 110 or receive data from server 110, and the time when server 110 next receives a request from the same sender and via the same communications channel to receive data from server 110.

Proxy detector 114 is preferably configured to determine the time delay for each of a predefined number of such acknowledgement-followed-by-a-data-request pairs from the same sender, such as for thirty such pairs, and then determine a representative time delay from one or more of the individual time delays, such as by calculating an average time delay or a median time delay.

Proxy detector 114 is configured to determine that communications that are received from a given sender represent proxy-based communications by determining that the representative time delay is consistent with a time delay that occurs between the time when an acknowledgement is received by a server and the time when a request for data that follows the acknowledgement is received by the server when the request is sent from a computer that is communicating via a proxy, such as where client 104 communicates with server 110 via a proxy, such as a computer 116, hereinafter referred to as proxy 116, that intermediates between client 104 and server 110. Proxy detector 114 is also preferably configured to provide a notification, such as to server 100, identifying a given sender as being a proxy, such as by providing the network address of the sender in the notification. Thus, for example, where server 100 provides instructions 102 within web page 108 to client 104 via proxy 116 in connection with a transaction, such as a banking transaction, and proxy detector 114 determines that server 110 is receiving data requests generated by instructions 102 via a proxy, namely proxy 116, proxy detector 114 preferably notifies server 100 that proxy 116 is a proxy, whereupon server 100 may subject the transaction to additional security measures, such as subjecting the transaction to further scrutiny, curtailing the transaction, or preventing the transaction from being completed.

Experimentation has shown that when a client computer is configured to establish a TCP connection with a server and then immediately begin issuing a series of requests to the server to receive data from the server, when the client communicates with the server without an intermediate proxy the average time delay is less than about 40 ms between the time when an acknowledgement from the computer is received by the server in response to the client receiving a communication from the server and the time when a subsequent data request from the client is received by the server. However, when the client communicates with the server via an intermediate proxy, it is the proxy that immediately sends an acknowledgement to the server in response to receiving a communication from the server. The proxy forwards the communication to the client, whereupon the client sends a request to the proxy to receive data from the server. The proxy then sends the request to the server. Due to the additional communications overhead between the server and the proxy and between the proxy and the client, the average time delay in this instance is greater than about 40 ms between the time when the acknowledgement from the proxy is received by the server and the time when the subsequent data request from the client is received by the server.

It is often the case that the greater the length of the time delay, the greater the physical distance between the proxy and the client, and thus the greater the likelihood that activities involving the proxy are fraudulent. This is because fraudulent activity often occurs when the proxy and the client are located in different countries. The distance between the proxy and the client may be estimated based on the time delay using conventional techniques, and this distance information may be included in the notification sent by proxy detector 114 and considered by server 100 when scrutinizing activities involving proxy 116.

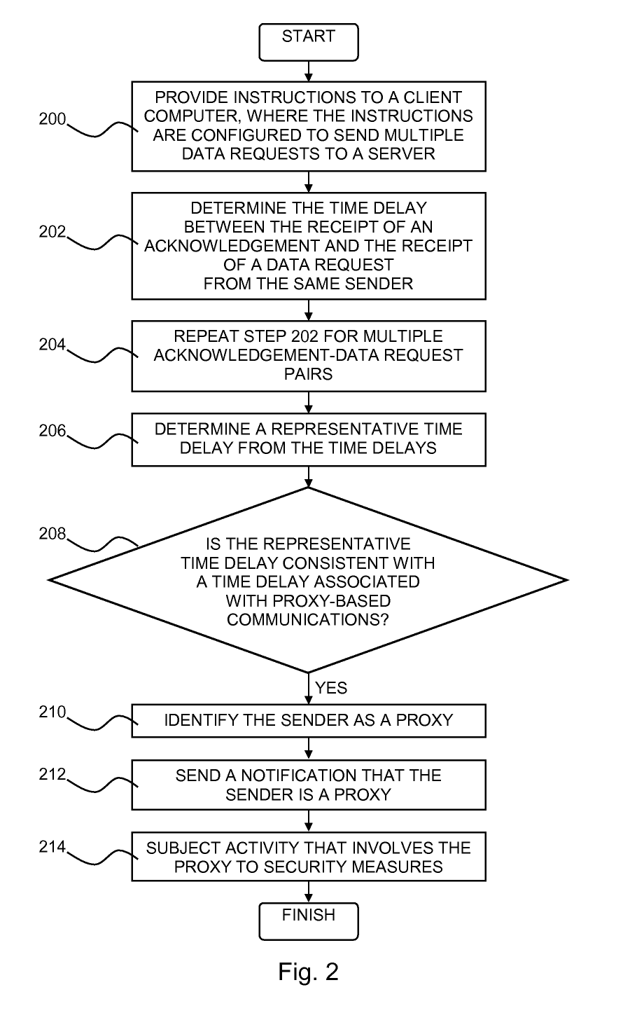

Reference is now made to FIG. 2 which is a simplified flowchart illustration of an exemplary method of operation of the system of FIG. 1, operative in accordance with an embodiment of the invention. In the method of FIG. 2, executable computer software instructions are provided to a client computer, where the instructions are configured as described hereinabove to establish communications with a server and thereafter send multiple requests to the server to receive data from the server (step 200). A time delay is determined between the time when an acknowledgement from a sender is received by the server and the time when a data request from the sender is received by the server (step 202). Step 202 is repeated for a predefined number of acknowledgement-followed-by-a-data-request pairs from the same sender (step 204), and a representative time delay is determined from the individual time delays (step 206). If the representative time delay is consistent with a predefined time delay that is associated with proxy-based communications (step 208), i.e., is consistent with a predefined time delay that occurs between the time when an acknowledgement is received by a server and the time when a request for data that follows the acknowledgement is received by the server when the request is sent from a computer that is communicating via a proxy, then the sender is identified as a proxy (step 210), whereupon a notification may be sent identifying the sender as a proxy (step 212), and activities that involve the proxy may be subject to additional security measures, such as by subjecting the activities to further scrutiny, curtailing the activities, or preventing the activities from being completed (step 214).

The system of FIG. 1 and method of FIG. 2 may be illustrated in the context of the following exemplary scenario in which: a computer user at client 104, communicating via proxy 116, uses web browser software at client 104 to navigate to an online banking web site that is hosted by server 100 and initiate a financial transaction; server 100 provides web page 108 to the web browser at client 104 via proxy 116, where web page 108 includes instructions 102 configured as described hereinabove; the web browser at client 104 executes instructions 102 and directs client 104 to request a TCP connection with server 110, which client 104 does via proxy 116; server 110 grants the TCP connection request and notifies proxy 116 that the TCP connection request is granted; proxy 116 sends an acknowledgement to server 110; server 110 receives the acknowledgement, whereupon communications detector 112 records the time when the acknowledgement is received; proxy 116 notifies client 104 that the TCP connection is established; client 104 sends a data request to server 110 via proxy 116; server 110 receives the data request, whereupon communications detector 112 records the time when the data request is received; proxy detector 114 determines the time delay between the time when the acknowledgement was received by server 110 and the time when the data request was received by server 110; proxy detector 114 determines a representative time delay for multiple acknowledgement-followed-by-a-data-request pairs received from proxy 116; proxy detector 114 determines that the representative time delay is consistent with is consistent with a predefined time delay that is associated with proxy-based communications, and therefore proxy 116 is a proxy; proxy detector 114 notifies server 100 that proxy 116 is a proxy; and server 100 subjects the financial transaction involving proxy 116 to additional security measures.

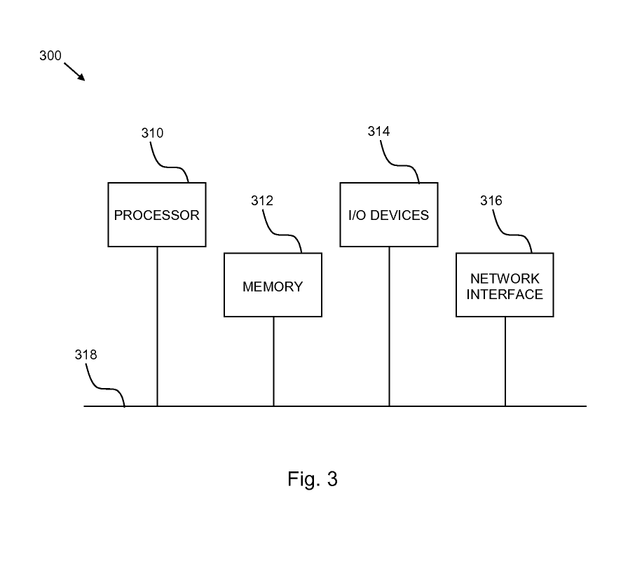

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for detecting proxy-based communications, the method comprising:
determining a plurality of time delays, wherein determining the plurality of time delays comprises, for each of the plurality of time delays:
detecting, by one or more processors, receipt of an acknowledgement at a first time, wherein the acknowledgement is responsive to a communication sent to a sender of the acknowledgement;
detecting, by one or more processors, receipt of a data request at a second time, wherein the data request is sent by the sender of the acknowledgement following the acknowledgement;
determining, by one or more processors, a time delay between the first time and the second time;
determining, by one or more processors, a representative time delay from the plurality of time delays; and
determining, by one or more processors, that the representative time delay is consistent with a predefined time delay that is associated with proxy-based communications, thereby identifying the sender as a proxy.

2. The method of claim 1, further comprising, prior to performing the detecting, a computer is configured with executable computer software instructions configured to send the data requests.

3. The method of claim 2, further comprising providing the executable computer software instructions to the computer.

4. The method of claim 3, wherein the providing comprises providing the executable computer software instructions within a web page.

5. The method of claim 1, further comprising providing a notification identifying the sender as a proxy.

6. The method of claim 5, further comprising subjecting an activity involving the sender to a security measure responsive to the notification.

7. A computer system for detecting proxy-based communications, the computer system comprising:
one or more computer processors;
one or more computer readable storage media;
program instructions stored on the one or more computer readable storage media for execution by at least one of the one or more computer processors, the program instructions comprising:
program instructions to determine a plurality of time delays, wherein the program instructions to determine the plurality of time delays comprise, for each of the plurality of time delays:
program instructions to detect receipt of an acknowledgement at a first time, wherein the acknowledgement is responsive to a communication sent to a sender of the acknowledgement;
program instructions to detect receipt of a data request at a second time, wherein the data request is sent by the sender of the acknowledgement following the acknowledgement;
program instructions to determine a time delay between the first time and the second time;
program instructions to determine a representative time delay from the plurality of time delays; and
program instructions to determine that the representative time delay is consistent with a predefined time delay that is associated with proxy-based communications, thereby identifying the sender as a proxy.

8. The computer system of claim 7, further comprising program instructions, stored on the one or more computer readable storage media for execution by at least one of the one or more computer processors, to, prior to performing the detecting, to configure a computer with executable computer software instructions configured to send the data requests.

9. The computer system of claim 8, further comprising program instructions, stored on the one or more computer readable storage media for execution by at least one of the one or more computer processors, to provide the executable computer software instructions to the computer.

10. The computer system of claim 9, wherein the program instructions to provide comprise program instructions to provide the executable computer software instructions within a web page.

11. The computer system of claim 7, further comprising program instructions, stored on the one or more computer readable storage media for execution by at least one of the one or more computer processors, to provide a notification identifying the sender as a proxy.

12. The computer system of claim 11, further comprising program instructions, stored on the one or more computer readable storage media for execution by at least one of the one or more computer processors, to subject an activity involving the sender to a security measure responsive to the notification.

13. A computer program product for detecting proxy-based communications, the computer program product comprising:
one or more computer readable storage media;
program instructions stored on the one or more computer readable storage media, the program instructions comprising:
program instructions to determine a plurality of time delays, wherein the program instructions to determine the plurality of time delays comprise, for each of the plurality of time delays:
program instructions to detect receipt of an acknowledgement at a first time, wherein the acknowledgement is responsive to a communication sent to a sender of the acknowledgement;
program instructions to detect receipt of a data request at a second time, wherein the data request is sent by the sender of the acknowledgement following the acknowledgement;
program instructions to determine a time delay between the first time and the second time;
program instructions to determine a representative time delay from the plurality of time delays; and
program instructions to determine that the representative time delay is consistent with a predefined time delay that is associated with proxy-based communications, thereby identifying the sender as a proxy.

14. The computer program product of claim 13, further comprising program instructions, stored on the one or more computer readable storage media, to, prior to performing the detecting, to configure a computer with executable computer software instructions configured to send the data requests.

15. The computer program product of claim 14, further comprising program instructions, stored on the one or more computer readable storage media, to provide the executable computer software instructions to the computer.

16. The computer program product of claim 15, wherein the program instructions to provide comprise program instructions to provide the executable computer software instructions within a web page.

17. The computer program product of claim 13, further comprising program instructions, stored on the one or more computer readable storage media, to provide a notification identifying the sender as a proxy.

18. The computer program product of claim 17, further comprising program instructions, stored on the one or more computer readable storage media, to subject an activity involving the sender to a security measure responsive to the notification.
